(19) United States
(12) Patent Application Publication
(10) Pub. No.: US 2012/0201600 A1
(43) Pub. Date: Aug. 9, 2012

(54) ASSEMBLED COMPONENT AND METHOD FOR PRODUCING AN ASSEMBLED COMPONENT

(75) Inventor: Thilo Studniorz, Rochlitz (DE)

(73) Assignee: Protektorwerk Florenz Maisch GmbH & Co. KG, Gaggenau (DE)

(21) Appl. No.: 13/496,994

(22) PCT Filed: Sep. 23, 2010
(86) PCT No.: PCT/EP2010/005833

§ 371 Date: Apr. 27, 2012

(30) Foreign Application Priority Data
Sep. 30, 2009 (DE) 10 2009 047 831.0

(51) Int. Cl. E04B 9/18; B23P 11/00; F16B 5/07

(52) U.S. Cl. 403/348; 29/428

(57) ABSTRACT

The invention relates to an assembled component comprising a first and a second component. The first component comprises a first flat two-dimensional connecting region, and the second component comprises a second flat two-dimensional connecting region connected to the first connecting region. The connecting regions each comprise at least two connecting sections, which are in each case formed as material sections bent out of the plane of the respective connecting region. The connecting regions each have a substantially arcuate edge. One end of the arcuate edge is arranged at a distance in a direction perpendicular to the plane of the respective connecting region. The end of the arcuate edge is adjoined by a further edge of the connecting region which runs obliquely or transversely with respect to the arcuate edge. The connecting sections each comprise a guide surface running obliquely with respect to the plane of the respective connecting region. In each case two connecting sections engage with one another, wherein in each case a guide surface of a connecting section of the first connecting region rests, at least in some areas, on a guide surface of a connecting section of the second connecting region.

The present invention relates to a component assembly comprising a first component and a second component, wherein the first component includes a first planar, shallow connection region and the second component includes a second planar, shallow connection region connected to the first connection region. The invention is furthermore directed to a method of manufacturing such a component assembly.

In many areas in which planar, shallow components or components having such connection regions have to be connected to one another, this connection takes place by rivet connections or screw connections which are relatively complex and expensive to manufacture.

An example is represented by suspension apparatus for carrier rails which usually comprise two different components, namely a base part which has A coupling section formed at its lower end for coupling to carrier rails for suspended ceilings and which includes a connection region in its upper region which is connected to a corresponding connection region of a spring-elastic connection part of the suspension apparatus. The spring-elastic connection part is usually made in U shape and had two holes in each of its limbs through which a bar-shaped fastening part can be inserted. The bar-shaped fastening part is clamped to the connection part due to the pretension of the U-shaped spring-elastic connection part so that an adjustable connection can be established between the connection part and the fastening part. The fastening of the connection part to the base part usually takes place by a rivet connection which is complex to establish and is associated with relatively high costs.

Connections of planar, shallow connection regions are also required in further sectors, in particular in the manufacture of metal sections or plastic sections.

It is an object of the present invention to provide a component assembly of the initially named kind which can be manufactured in a simple and inexpensive manner. Furthermore, a method for manufacturing such a component assembly should be provided.

Starting from a component assembly of the initially named kind, this object is satisfied in accordance with the invention in that the connection regions each include at least two connection sections which are each formed as material sections bent out of the plane of the respective connection region, in that the connection sections each have an edge made in substantially arcuate shape, in that an end of the arcuate edge is arranged spaced in a direction perpendicular to the plane of the respective connection region, in that a further edge of the connection section adjoins the end of the arcuate edge and extends obliquely or transversely to the arcuate edge, in that the connection sections each include a guide surface extending obliquely to the plane of the respective connection region, and in that two respective connection sections mesh with one another, wherein the respective guide surface of a connection section of the first connection region at least regionally contacts a guide surface of a connection section of the second connection region.

A method in accordance with the invention for manufacturing such a component assembly is characterized in that slits or openings are produced in the connection regions which each have at least one substantially arcuate edge, in that by production of a further slit or of a further opening at one of the ends of each of the arcuate edges, a respective further edge is produced which adjoins it and which extends obliquely or transversely to the arcuate edge, in that at least two respective connection sections are produced in the connection regions by material sections respectively bordered by the arcuate edge and by the further edge are bent out of the plane of the respective connection region so that an end of the arcuate edge is arranged spaced in a direction perpendicular to the plane of the respective connection region and the connection sections each include a guide surface extending obliquely to the plane of the respective connection region and that the components are attached to one another and are rotated with respect to one another such that two respective connection sections engage into one another and the respective guide surface of a connection section of the first connection region at least regionally contacts a guide surface of a connection section of the second connection region.

In accordance with the invention, no additional connection part is thus required to connect the two components of the component assembly to one another. A respective material section can be bent out of the plane of the respective connection region by the planar, shallow design of the connection regions, with this bending out taking place such that a type of partial thread section is produced at each of the two connection regions. The correspondingly formed connection sections have obliquely extending guide surfaces which contact one another on meshing and which draw the two components together and ultimately firmly connect them to one another by rotating the two components with respect to one another in the sense of a screw movement.

With mutually connected components, the edges each act as contact edges so that in a predefined load direction, that is, for example, in a perpendicular direction in the event of a component assembly formed as a suspension apparatus, forces can be received and the two components of the component assembly are securely held together.

In accordance with an advantageous embodiment of the invention, the other end of the arcuate edge lies in the plane of the connection region. The end of the further edge disposed remote from the arcuate edge preferably likewise lies in the plane of the connection region. It is thereby ensured that, on the rotating of the two components with respect to one another, they are completely drawn together and the planar, shallow connection regions ultimately contact one another in the assembled state.

One or more of the arcuate edges are advantageously formed by arcuate slits formed in the respective connection region. In this manner, the required arcuate edges can be manufactured very simply without the material of the components being substantially weakened. It is generally also possible that larger openings are introduced into the components instead of slits as long as the required arcuate edges are respectively formed by these openings.

In accordance with a further advantageous embodiment of the invention, the connection sections of a component are each arranged on the same side of the component. It is thereby ensured that at least two respective connection sections are arranged on one side of a component which can each engage into two respective connection parts arranged on a side of the other component.

The further edge is preferably arranged as a straight line. The further edge in particular extends in this respect, starting from the end of the arcuate edge, outwardly or inwardly in the radial direction. A straight-line edge can take up the forces occurring in the assembled state particularly easily since it can be arranged so that the occurring forces act substantially perpendicular on the edge.

In accordance with a further advantageous embodiment of the invention, one or more of the arcuate edges are formed as an edge of with respect to circular shape, in particular as a quadrant arc. It is thereby ensured that a rotation of the components with respect to one another for connecting the two components is possible without problem. The edges generally do not have to made mathematically exactly in partially circular shape since a rotation of the components with respect to one another is also possible with edges not of ideal partially circular form, for example due to tolerances in the production of the slits or openings.

In accordance with a further preferred embodiment of the invention, the connection sections of a connection region are each arranged with point symmetry to a common center of the partially circular edges. The partially circular edges in particular each have the same center. This design also assists the simple rotation of the two components with respect to one another on the connection.

The partially circular edges of a connection region advantageously each have the same radius. In this respect, the partially circular edges of one of the connection regions preferably have a larger radius than the partially circular edges of the other connection region. It is thereby ensured that the connection sections can engage into one another on the joining together and can be rotated with respect to one another.

In accordance with a further advantageous embodiment of the invention, the respective further edge adjoining a partially circular edge with the larger radius extends, starting from the end of the partially circular edge, in the radial direction inwardly, whereas the respective further edge adjoining a partially circular edge with the smaller radius extends, starting from the end of the partially circular edge, in the radial direction outwardly.

In accordance with a further advantageous embodiment of the invention, the two components and in particular the connection regions are latched to one another. For this purpose, beads or other latch elements can be formed in the connection regions, for example, which engage into one another or engage beneath one another with components rotated with respect to one another.

The connection between the first connection region and the second connection region is advantageously made releasable. This can be achieved, for example, with or without the previously named latch connection or by an additional screw connection. It is generally also possible that the components are non-releasably connected to one another after the complete rotation of the components with respect to one another. This can take place, for example, by a pressure joining process such as clinching or crimping or by clamping, squeezing, pressing, welding, adhesive bonding or riveting.

The first component and/or the second component is/are preferably composed of metal or of plastic.

A component assembly in accordance with the invention can, for example, be used as a suspension apparatus for carrier rails, in particular for suspended ceilings or the like. Such a suspension apparatus includes a base part which is formed for coupling to a carrier rail and a spring-elastic connection part fastened to the base part which is formed for the adjustable connection of the base part to a fastening part. The suspension apparatus is formed by a component assembly formed in accordance with the invention, with the base part being formed by the first component and the connection part being formed by the second component.

Further advantageous embodiments are set forth in the dependent claims.

The invention will be described in more detail in the following with reference to embodiments and to the drawings; there are shown in these:

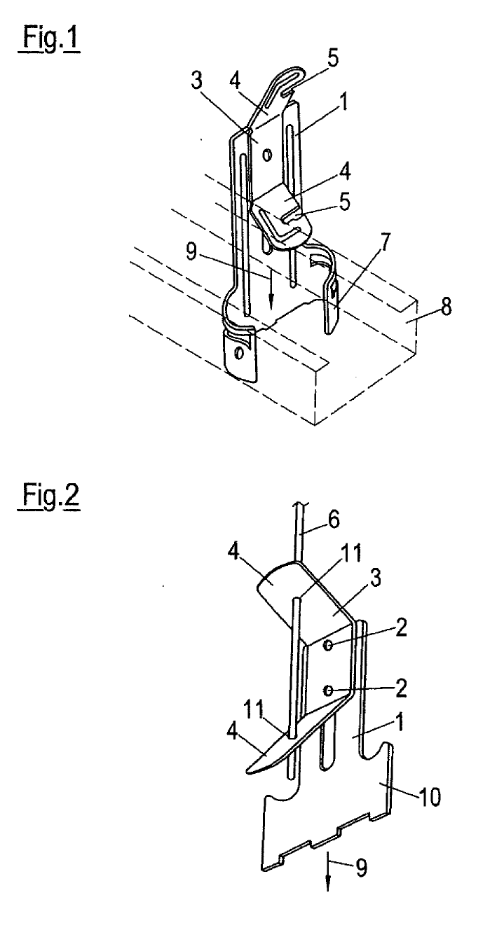

FIG. 1 a perspective representation of a suspension apparatus in accordance with the prior art;

FIG. 2 a perspective representation of a further suspension apparatus in accordance with the prior art;

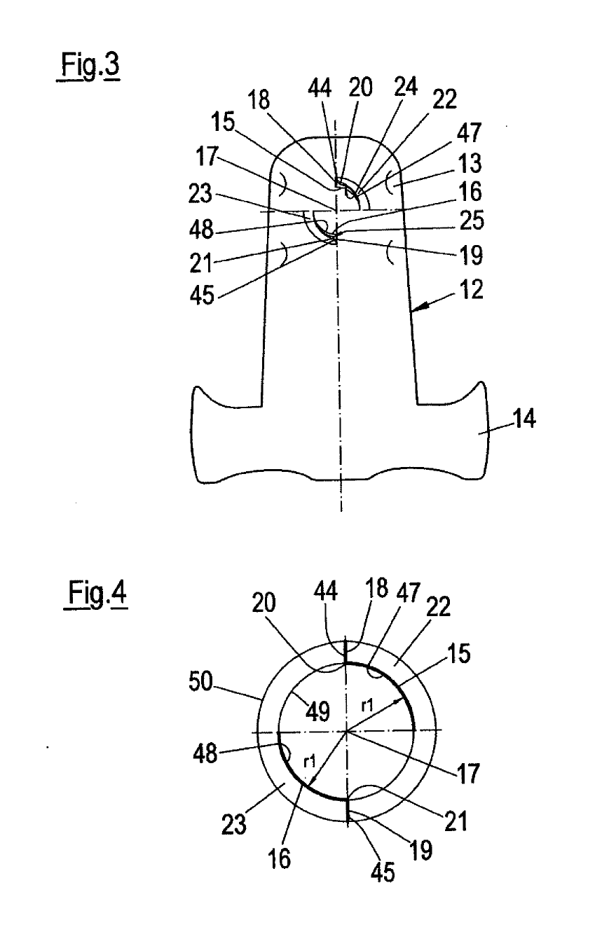

FIG. 3 a first component of a component assembly formed in accordance with the invention in a front view;

FIG. 4 a cutting pattern for the first component in accordance with FIG. 3;

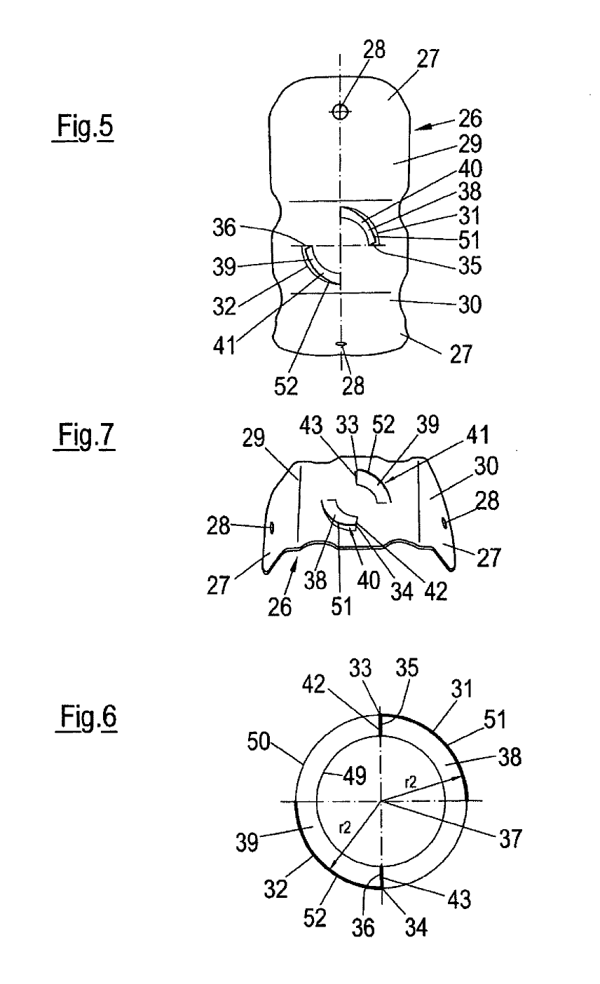

FIG. 5 a second component of a component assembly formed in accordance with the invention in a front view;

FIG. 6 a cutting pattern for the first component in accordance with FIG. 5;

FIG. 7 a perspective rear view of the second component in accordance with FIG. 6;

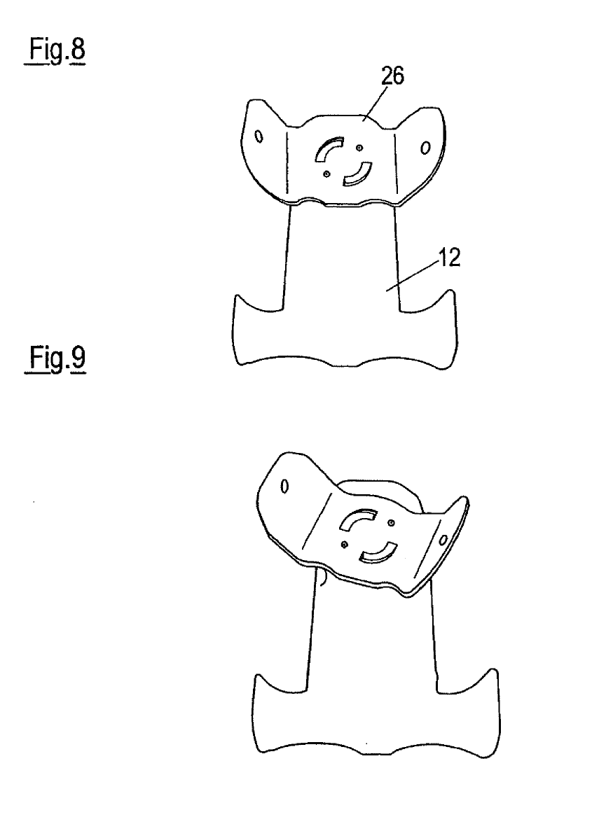

FIGS. 8 to 10 the first and second components in accordance with FIGS. 3 and 5 in three different positions during assembly;

FIG. 11 a front view of the component assembly in the assembled state; and

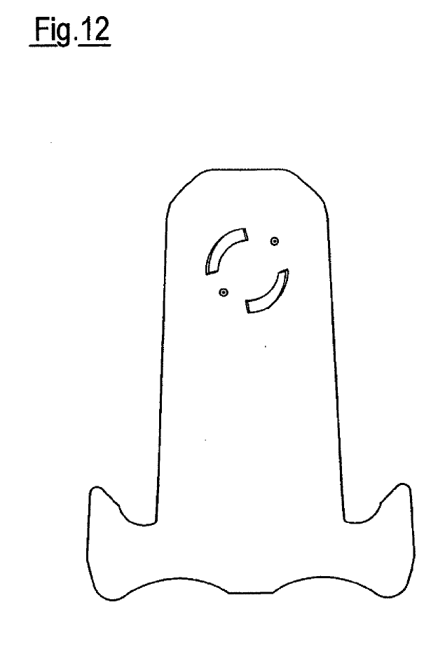

FIG. 12 a rear view of the component assembly in the assembled state.

FIG. 1 shows a component assembly in the form of a known suspension apparatus which includes a base part 1 as well as a connection part 3 fastened to the base part 1 via a rivet 2. The connection part has a U-shaped longitudinal section having two limbs 4 in which slit-shaped openings 5 are formed into which a bar-shaped fastening part 6 (see FIG. 2) can be laterally inserted.

Whereas the base part 1 usually comprises simple sheet metal, the connection part 3 is formed from spring steel to hold the fastening part 6 securely in the openings 5. For this purpose, the two limbs 4 are first bent toward one another and are released again after inserting the fastening part 6 into the openings 5 so that the fastening part 6 is clamped in the openings 5 due to the spring pretension of the connection part 3. The upper end of the fastening part 6 can then be fastened to a ceiling in a conventional manner so that ultimately the total suspension apparatus is securely fastened to the ceiling.

At the lower end of the base part 1, a coupling section 7 is formed which is designed for coupling to a carrier rail 8 shown by a dashed line. Further transversely extending carrier rails can be formed at the carrier rail 8 which are designed, for example, for carrying plates for suspended ceilings.

With an installed suspension apparatus, the base part 1 and the connection part 2 are loaded by the weight of the carrier rail 8 and by the weight of the elements carried by it in a load direction shown by an arrow 9.

FIG. 2 shows a further suspension apparatus in accordance with the prior art which differs from the suspension apparatus in accordance with FIG. 1 by a modified coupling section 10 as well as by modified openings 11 in the limbs 4 of the connection part 3. The openings 11 are not made laterally open in the embodiment in accordance with FIG. 2 so that the fastening part 6 cannot be laterally introduced, but has to be pushed through the openings 5. The connection part 3 in the suspension apparatus in accordance with FIG. 2 is furthermore connected to the base part 1 via two rivets 2.

The design and in particular the fastening of the connection part 3 at the base part 1 in the embodiment in accordance with FIG. 2, however, generally correspond to the embodiment in accordance with FIG. 1 so that elements which are similar or the same are marked by the same reference numerals as in FIG. 1.

FIG. 3 shows a first component 12 of a component assembly which is formed in accordance with the invention and which forms a base part of a suspension apparatus in accordance with the invention. The first component 12 includes in its upper region a first planar, shallow connection region 13 and in its lower region a coupling section 14 which is designed for coupling to a carrier rail.

Two slits 15, 16, which are of quadrant shape and which are arranged with point symmetry to a common center 17 are formed in the first planar, shallow connection region 13.

An enlarged representation of the corresponding cutting pattern is shown for better illustration in FIG. 4. It can clearly be recognized from this representation that the slits 15, 16 extend in quadrant form about the common center 17 and a respective radially outwardly extending straight-line slit 18, 19 adjoins each of the quadrant-shaped slits 15, 16.

It can be seen from FIG. 3 that material sections of the first component 12 which are bordered by the slits 15, 18 or 16, 19 are bent upwardly out of the plane of the first connection region 13. The material section bordered by the slits 15, 18 or 16, 19 respectively forms a connection section 22, 23 of the first connection region, with each connection section 22, 23 including a guide surface 24, 25 (lower side of the connection sections 22, 23 in FIG. 3) extending obliquely to the first connection region 13. The connection sections 22, 23 are radially inwardly bounded by arcuate edges 47, 48, with a respective end 20, 21 of the arcuate edges 47, 48 being arranged spaced in a direction perpendicular to the plane of the first connection region 13. Radially outwardly extending straight-line, end-face further edges 44, 46 adjoin the arcuate edges 47, 48.

As can furthermore be recognized from FIG. 4, the quadrant-shaped slits 15, 16 each have the same radius r₁.

FIG. 5 shows a second component 26 of the component assembly in accordance with the invention which forms a connection part of the suspension apparatus. The second component 26 has a U-shaped longitudinal section having two limbs 27 in which a respective opening 28 is formed. The second component 26 is formed from spring steel and can, as is shown in FIGS. 1 and 2 on the prior art, be used for receiving a bar-shaped fastening part.

A center part 29 of the second component 26 connecting the two limbs 27 includes a second planar, shallow connection region 30.

Two quadrant-shaped slits 31, 32 are formed in the second connection region 30, with a straight-line slit 35, 36 adjoining a respective end 33, 34 of the quadrant-shaped slits 31, 32 extending radially inwardly. The individual slits 31, 32, 35, 36 can be recognized more clearly in a cutting pattern shown in FIG. 6.

The quadrant-shaped slits 31, 32 have a common center 37 and each have radii r₂ of equal size.

As in particular a comparison of FIGS. 4 and 6 shows, the radius r₂ is larger than the radius r₁. The auxiliary circular lines 49 drawn in FIGS. 4 and 6 and also the auxiliary circular lines 50 are identical so that the respective free ends of the slits 18, 19 of FIG. 4 come to lie on the auxiliary circular line 50 of the quadrant-shaped slits 31, 32 (FIG. 6), whereas the free ends of the slits 35, 36 each come to lie on the auxiliary circular line 49 of the quadrant-shaped slits 15, 16 (FIG. 4).

It can be recognized from FIG. 5, and in particular also from FIG. 7, that material sections of the second component 26 bounded by the slits 31, 35 and 32, 36 respectively are bent out of the plane of the second connection region 30 in a similar manner as was described with respect to FIG. 3. However, the material sections are bent out in the opposite direction, i.e. in FIG. 5 into the drawing plane rearwardly from the second connection region 30. The bent-out material sections form connection sections 38, 39 of the second connection region 30 which are each radially outwardly bounded by arcuate edges 51, 52. Radially inwardly extending straight-line, end-face further edges 42, 43 adjoin the arcuate edges 51, 52. Whereas the ends 33, 34 of the arcuate edges 51, 52 are in turn arranged spaced in a direction perpendicular to the plane of the second connection region 30, the oppositely disposed ends are arranged in the plane of the second connection region 30 so that the connection sections 38, 39 each include guide surfaces 40, 41 extending obliquely to the plane of the second connection region.

The connection sections 22, 23 and 38, 39 are thus formed helically or spirally over a part circumference of approximately 90° and can be screwed together due to their dimensioning, as is shown in FIGS. 8 to 11.

The two components 12, 26 are initially placed onto one another for connecting the first component 12 to the second component 26, as is shown in FIG. 8. In this respect, the end-face further edges 42, 43 of the connection sections 38, 39 are first positioned opposite the end-face further edges 44, 45 of the connection section 22, 23, as is shown in FIG. 8. The second component 26 is then pressed toward the first component 12 and rotated clockwise so that the end-face further edges 42, 43 are pushed beneath the end-face further edges 44, 45 so that the guide surfaces 40, 41 are arranged beneath the guide surfaces 24, 25 and come into contact with them.

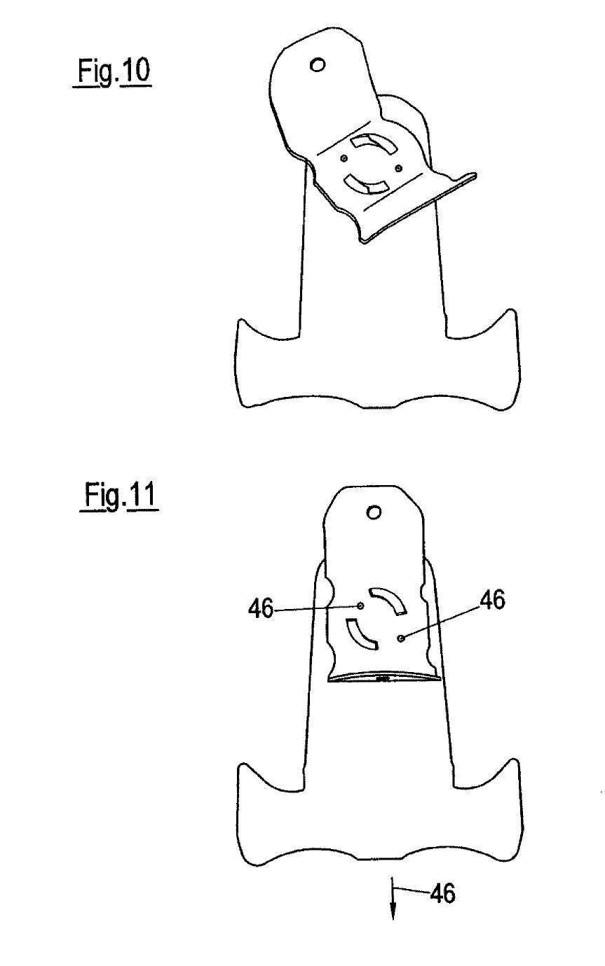

On a further clockwise rotation in accordance with FIGS. 9 and 10, the first and second components 12, 26 are drawn together by the guide surfaces 24, 25, 40, 41 sliding toward one another until the end position shown in FIG. 11 is reached. In this assembled state, the first and second connection sections 13, 30 contact one another areally and are pressed toward one another by the guide surfaces 24, 25, 40, 41 and are thus firmly held together.

In addition, latch elements can be provided at the first and second components 12, 26 to achieve a latching of the two components 12, 26 in the end position shown in FIG. 11. This latch connection can take place, for example, by beads 46 which are indicated in FIG. 11 and which can engage into corresponding beads, not shown, in the first component 12 or can engage beneath corresponding projections. Instead of beads, other latch elements can also be provided, for example in the form of elevated portions, recesses or openings.

The connection between the first and second components 12, 26 can in particular be loaded in a load direction indicated by an arrow 46 in FIG. 11 as well as perpendicular thereto without the connection being able to be released. A loading in the direction of angles disposed therebetween is also possible at any time since all engaging forces can be reliably taken up without releasing the connection due to the concentric design of the connection as long as the forces substantially extend through the centers 17, 37.

Shallow elements in accordance with the invention are to be understood as metal sheets as well as all thin, plate-like or panel-like components or connection regions whose thickness is much smaller than their length and width, with the elements being able to be manufactured from metal and from plastic or from other suitable materials.

### REFERENCE NUMERAL LIST

1 base part
2 rivet
3 connection part
4 limb
5 openings
6 fastening part
7 coupling section
8 carrier rail
9 arrow (load direction)
10 coupling section
11 openings
12 first component
13 first connection region
14 coupling section
15 slit
16 slit
17 center
18 slit
19 slit
20 end of the edge 47
21 end of the edge 48
22 connection section
23 connection section
24 guide surface
25 guide surface
26 second component
27 limb
28 openings
29 center part
30 second connection region
31 slit
32 slit
33 end of the edge 51
34 end of the edge 52
35 slit
36 slit
37 center
38 connection section
39 connection section
40 guide surface
41 guide surface
42 edge
43 edge
44 edge
45 edge
46 load direction
47 arcuate edge
48 arcuate edge
49 auxiliary circular line
50 auxiliary circular line
51 arcuate edge
52 arcuate edge
r₁ radius
r₂ radius

1. A component assembly comprising a first and a second component (12, 26), wherein the first component (12) includes a first planar, shallow, connection region (13) having a plane and the second component (26) includes a second planar, shallow, connection region (30) connected to the first connection region (13) and having a plane;
wherein the connection regions (13, 30) each include at least first and second connection sections (22, 23, 38, 39) which are each formed as material sections bent out of the plane of the respective connection region (13, 30);
wherein, with assembled first and second components (12, 26), at least two connection sections (22, 23) of first component (12) engage into respective connection sections (38, 39) of the second component (26),
wherein
the connection sections (22, 23, 38, 39) each have a substantially arcuate edge (47, 48, 51, 52) each arcuate edge having first and second ends (20, 21, 33, 34);
wherein the first end (20, 21, 33, 34) of each arcuate edge (47, 48, 51, 52) is arranged spaced from the plane of the respective connection region (13, 30) in a direction perpendicular to that plane;
wherein each connection section (22, 23, 38, 39) has a further edge (44, 45, 42, 43) extending from the respective second end obliquely or transversely to the arcuate edge (47, 48, 51, 52);
wherein each arcuate edge (47, 48, 51, 52) and the associated further edge (44, 45, 42, 43) bound a guide surface (24, 25, 40, 41) of the respective connection section (22, 23, 38, 39) extending obliquely to the plane of the respective connection region (13, 30),
with respective guide surfaces (24, 25) of the first and second connection sections (22, 23) of the first connection region (13) and respective guide surfaces (40, 41) of the first and second connection sections (38, 39) of the second connection region (30) mating with each other so that, on the assembly of the first and second components (12, 26), the guide surfaces (24, 25; 40, 41) slide on one another and, with assembled first and second components (12, 26), contact one another at least regionally.

2. A component assembly in accordance with claim 1,
wherein the second end of each arcuate edge (47, 48, 51, 52) lies in the plane of the connection region (13, 30).

3. A component assembly in accordance with claim 1,
wherein
each further edge (44, 45, 42, 43) has a further end disposed remote from the associated arcuate edge (47, 48, 51, 52), the further end lying in the plane of the respective connection region (13, 30).

4. A component assembly in accordance with claim 1,
wherein
each arcuate edge (47, 48, 51, 52) is formed by an arcuate slit (15, 16, 31, 32) formed in the respective connection region (13, 30).

5. A component assembly in accordance with claim 1,
wherein
the first and second connection sections (22, 23, 38, 39) of each component (12, 26) are each arranged on the same side of the component (12, 26).

6. A component assembly in accordance with claim 1,
wherein
each further edge (44, 45, 42, 43) lies in a straight line.

7. A component assembly in accordance with claim 1,
wherein
each further edge (44, 45, 42, 43) extends, starting from the first end (20, 21, 33, 34) of the associated arcuate edge (47, 48, 51, 52), outwardly or inwardly in a radial direction relative to the arcuate edge.

8. A component assembly in accordance with claim 1,
wherein
one or more of the arcuate edges (47, 48, 51, 52) are formed as a partially circular edge.

9. A component assembly in accordance with claim 1,
wherein
the arcuate edges (47, 48, 51, 52) of the connection sections (22, 23, 38, 39) of a connection region (13, 30) are each arranged with point symmetry to a common center (17, 37).

10. A component assembly in accordance with claim 1,
wherein
the arcuate edges (47, 48, 51, 52) of the connection sections (22, 23, 38, 39) of a connection region (13, 30) have a common center (17, 37).

11. A component assembly in accordance with claim 1,
wherein
the arcuate edges (47, 48, 51, 52) of the connection sections (22, 23, 38. 39) of each connection region (13, 30) have the same radius (r₁, r₂).

12. A component assembly in accordance with claim 1,
wherein
the arcuate edges (51, 52) of the connection sections (38, 39) of the second the connection region (30) have a larger radius (r₂) than the arcuate edges (47, 48) of the connection sections (22, 23) of the first connection region (13).

13. A component assembly in accordance with claim 12,
wherein
the further edges (42, 43) of the arcuate edges of the larger radius (r₂) extend, starting from the associated first ends (33, 34) of the associated arcuate edges (51, 52), inwardly in a radial direction; and wherein the further edges (44, 45) of the arcuate edges (47, 48) of the smaller radius (rₜ) extend, starting from the associated first end (20, 21) of the associated arcuate edges (47, 48), outwardly in a radial direction.

14. A component assembly in accordance with claim 1,
wherein
the first and second components (12, 26) are latched to one another in the first and second connection regions (13, 30).

15. A component assembly in accordance with claim 1,
wherein
at least one of the first component (12) and the second component (26) is comprised of metal.

16. A component assembly in accordance with claim 1,
wherein
the first and second components (12, 26) are releasably connectable to one another in the first and second connection regions (13, 30).

17. A component assembly in accordance with claim 1 when used in a suspension apparatus for carrier rails (8), the suspension apparatus including a fastening part (6), a spring elastic connection part (3) and a connection part, the first component (12) being a base part designed for coupling to a carrier rail (8), the spring-elastic connection part is being fastened to the base part and being designed for an adjustable connection of the base part the fastening part, and
the connection part being formed by the second component (26).

18. A method of manufacturing a component assembly, comprising a first and a second component (12, 26), wherein the first component (12) includes a first planar, shallow connection region (13) and the second component (26) includes a second planar, shallow connection region (30) connected to the first connection region (13),
the method comprising the steps of forming at least first and second connection sections (22, 23, 38, 39) each having a substantially arcuate edge (47,48, 51, 52) having first and second ends (20, 21, 33, 34) and respective further edges (44, 45, 42, 43) respectively adjoining the first ends (20, 21, 33, 34) of each arcuate edge (47, 48, 51, 52) by producing slits (15, 16, 31, 32) or openings in the connection regions (13, 30), the further edges (44, 45, 42, 43) extending obliquely or transversely to the respective arcuate edges (47, 48, 51, 52) thereby defining a plurality of material sections each bordered by an arcuate edge (47, 48, 51, 52) and by a further edge (44, 45, 42 43) associated with it,
the method further comprising the steps of:
bending the material sections out respective planes of the connection regions (13, 30) so that a first end (20, 31, 33, 34) of each arcuate edge (47, 48, 51, 52) is spaced from the associated plane in a direction perpendicular to the associated planes, the material sections defining respective guide surfaces (24, 25, 40, 41) extending obliquely to the plane of the respective connection region (13, 30);
attaching the first and second components (12, 26) to one another by placing them together and rotating them with respect to one another such that first and second connection sections (22, 23) of the first component (12) engage with first and second connection sections (38, 39) of the second component (26) with the respective guide surfaces (24, 25) of the first and second connection sections (22, 23) of the first connection region (13) sliding along the guide surface (40, 41) of the first and second connection sections (38, 39) of the second connection region (30) and at least regionally contacting one another.

19. A component assembly in accordance with claim 8,
wherein each arcuate edge (47, 48, 51, 52) is a 90 degree circular arc.

20. A component assembly in accordance with claim 1,
wherein at least one of the first component (12) and the second component (26) is comprised of plastic.

21. A component assembly in accordance with claim 17,
wherein the suspension apparatus is for suspended ceilings.
